(19) United States
(12) Patent Application Publication
(10) Pub. No.: US 2007/0163469 A1
(43) Pub. Date: Jul. 19, 2007

(54) ENGINE BLOCK SEALANT COMPOSITIONS AND METHODS FOR THEIR USE

(75) Inventor: Douglas Erick, Dunkirk, NY (US)

Correspondence Address: GIFFORD, KRASS, SPRINKLE,ANDERSON & CITKOWSKI, P.C, PO BOX 7021, TROY, MI, 48007-7021, US

(73) Assignee: Bar's Products, Inc., Holly, MI (US)

(21) Appl. No.: 11/620,653

(22) Filed: Jan. 6, 2007

Related U.S. Application Data
(60) Provisional application No. 60/757,230, filed on Jan. 9, 2006.

(51) Int. Cl. C04B 28/26; C04B 12/04

(52) U.S. Cl. 106/600; 106/624; 106/634

(57) ABSTRACT

A composition for sealing leaks in an engine includes a water-soluble metal silicate, a body of organic fibers, and a body of inorganic fibers. The organic fibers may include synthetic polymeric fibers as well as natural fibers such as cellulose and animal-derived materials. The inorganic fibers may include refractory fibers such as glass, ceramic or mineral fibers. The composition may be prepared in the form of a dry material or as a solution. Also disclosed are methods for using the composition.

### CROSS-REFERENCE TO RELATED APPLICATIONS

This application claims priority of U.S. Provisional Patent Application Ser. No. 60/757,230 filed Jan. 9, 2006, entitled “Engine Block Sealant Composition and Method for its Use.”

### FIELD OF THE INVENTION

This invention relates generally to sealant compositions. More specifically, the invention relates to compositions for sealing leaks in internal combustion engine blocks and related structures.

### BACKGROUND OF THE INVENTION

Internal combustion engines generally include jackets and passages therein which allow for the circulation of a coolant fluid during the operation of the engine. In some instances, the engine block or cylinder head can develop a crack or hole (which terms are used interchangeably herein) which permits coolant fluid to leak therethrough. Also, problems can occur with leaks in the various gaskets, such as the head gasket or intake gasket, which are used to form seals between the various components of the engine. This problem is particularly prevalent in those instances where the engine components are made of different metals such as is the case when an aluminum head is mounted on a cast iron block. In such instances differential expansion of the different metals can cause gaskets to fail, thus causing engine leaks. All of these problems of leakage are compounded by the fact that in operation, the engine block is exposed to very high pressure and temperature conditions as well as to reactive species generated by the combustion process. These extreme conditions can rapidly increase the size of any crack, hole or gasket leak leading to catastrophic failure.

The prior art has proposed a number of compositions for sealing leaks in engine blocks, heads and gaskets. These compositions are generally based upon a combination of a filler material with a cementing material. Some such compositions are shown in U.S. Pat. Nos. 6,767,395; 4,524,159; 4,439,561; 6,159,276; and 6,840,990. Such prior art compositions have been inadequate for their intended purpose. In some instances, the compositions do not have sufficient thermal stability to provide a good, long-term seal of an engine leak. Other compositions are relatively effective in sealing small leaks, but cannot seal large leaks. Conversely, yet other compositions can seal relatively large leaks, but do not address small leaks.

There is thus a need for an engine block sealant composition which is compatible with coolant fluids and chemically and mechanically stable under the extreme operating conditions generated in an internal combustion engine. Such compositions should also be capable of sealing both large and small leaks. Also, in many applications, it is desirable that the sealant composition not alter the color, or other appearance qualities, of the coolant fluid. Furthermore, the compositions should be simple to use, safe and relatively low in cost. As will be explained, the present invention provides a composition for sealing engine block leaks which meets these criteria.

### SUMMARY OF THE INVENTION

Disclosed herein is a composition for sealing leaks in an engine. The composition comprises a water-soluble metal silicate, a body of organic fibers, and a body of inorganic fibers. The composition may be formulated in a dry form or as a liquid by the inclusion of water and/or additional solvents.

In specific embodiments, the inorganic fibers of the composition may be glass fibers , ceramic fibers, mineral fibers, or various combinations. In some embodiments, the organic fibers comprise a mixture of different types of organic fibers, and these fibers may be selected from members comprising synthetic polymers, vegetable fibers, and animal fibers. In some instances, the vegetable fibers may comprise cellulose fibers and these fibers may be a mixture of fibers of two different lengths. The animal fibers, in some instances, may comprise leather fibers. The synthetic polymer fibers may comprise a mixture of different types of organic polymers, or they may comprise a single polymer. In particular instances, the fibers may be fibrillated. In other instances, the organic fibers may include thermoplastic fibers. Particular compositions may include a refractory fiber.

In specific compositions which are water based, various components may comprise, on a weight basis, 40-80% of the water-soluble metal silicate; 0.5-1.0% of a first, fibrillated polymeric fiber; 0.5-0.5% of a second, aramid polymeric fiber; 0.5-0.5% of a refractory fiber; 0.5-0.5% of a first cellulose fiber having a first length; 0.5-5.0% of a second cellulose fiber having a second length different from said first length; and 0.5-1.0% of a leather fiber. The balance of the composition will be water and/or a water-miscible solvent such as a glycol. In those instances where the composition is being fabricated as a dry material, the water will be eliminated and the percentages adjusted accordingly.

Also disclosed herein are methods for using the composition.

### DETAILED DESCRIPTION OF THE PREFERRED EMBODIMENTS

The sealant composition of the present invention is based upon a mixture of a water-soluble metal silicate together with a body of organic fibers and a body of inorganic fibers. The combination of these materials acts synergistically to seal both large and small leaks in engine blocks. The seal formed by the composition is stable under high-temperature, high-pressure and corrosive conditions encountered in an internal combustion engine.

The water-soluble metal silicate typically comprises an alkali metal silicate such as sodium silicate or potassium silicate, and in particular embodiments the material is sodium silicate. Sodium silicate, which is also referred to as water glass, can comprise one or more of those compounds produced by reacting silicon dioxide with sodium carbonate, and these include sodium orthosilicate, sodium metasilicate, sodium polysilicate and sodium pyrosilicate. Other silicates such as magnesium silicates may also be employed, and all of these various materials may be used in combination.

The organic fibers may comprise one or more of: fibers of a synthetic polymer, vegetable fibers and animal fibers. In a particular embodiment of the invention, the organic fibers comprise a mixture of different types of fibers. In one embodiment of the invention, the organic fibers include a mixture of synthetic polymeric fibers, vegetable fibers and animal fibers.

Among some of the synthetic polymeric fibers which may be employed are aramid fibers such as fibers of the material sold under the trade name Kevlar®. These fibers are very stable at high temperatures and are also extremely strong and resistant to harsh chemical environments. Polyethylene, polypropylene and other such thermoplastic materials may also be used in the practice of the present invention. Fibers of these materials tend to soften under high-temperature conditions (typically 100-300° C.) and provide a high-viscosity thermoplastic bond which holds the other fibers in the composition together. Such materials also have very good chemical resistivity.

In some instances, it is preferable that one or more of the polymeric fibers be fibrillated. As is known in the art, fibrillated fibers are frayed or otherwise split along portions of their length to provide a very high-surface area. The fibrillated areas act as hooks which enable fibers to knit together to form a very strong bond which aids in sealing engine block cracks. In a specific embodiment of the present invention, the polymeric material employed comprises a mixture of aramid fibers together with fibrillated thermoplastic fibers.

Vegetable fibers, such as cellulose fibers, may also be employed as the organic fibers in the present invention. These fibers can be derived from textile waste, agricultural waste or the lice. Such vegetable fibers are primarily comprised of cellulose which is thermally stable and has very good resistivity to chemical attack. In one particular embodiment of the present invention, the composition includes cellulose fibers of at least two different lengths. In one specific formulation, the composition includes a first body of cellulose fibers having a length in the approximate range of 0.150 mm (150 microns) and a second body of fibers having a length of approximately 0.3 mm (300 microns).

In yet other instances, the organic fibers may include animal derived organic fibers such as fibers derived from hair or hides. Such fibers can absorb liquid and swell to effectively seal leaks. One animal-derived fiber having utility in the present invention is leather fiber. This material, also referred to as leather cotton, is a fibrous byproduct obtained from leather buffing.

There are a variety of inorganic fibers which may be employed in the present invention. These fibers are generally characterized as being refractory insofar as they are stable under very high-temperature conditions, which are understood to be temperatures of at least 500° C., and in specific instances temperatures of at least 1000° C. The inclusion of the refractory fibers provides high-temperature strength to the seal formed by the compositions of the present invention. Ceramic fibers such as alumino silicate fibers comprise one refractory fiber which may be employed in the present invention. Other refractory fibers include glass fibers as well as natural or synthetic mineral fibers.

The compositions may be compounded as a dry mixture, in the form of tablets, powders or capsules, which are added to the coolant fluid of a motor vehicle. Alternatively, the compositions may include water and/or organic liquids such as glycols, alcohols, ethers and the like in an amount sufficient to dissolve the silicate and suspend the fibrous material. The compositions may also include ancillary ingredients such as thickening agents and wetting agents as well as pigments, dyes, fragrances and other agents designed to enhance the aesthetic appeal of the product. Although, as noted above, it is a particular feature of the compositions that they may be prepared so that they do not change the normal appearance of coolant fluid compositions.

There are a number of compositions which may be prepared in accord with the teaching presented herein. One specific composition comprises, on a weight percent basis: 60% sodium silicate, 36.14% water and 0.60% of a xanthan gum thickener. The composition also includes a first polymeric fiber in an amount of 0.56%. This fiber is a fibrillated polyester sold by the International Fiber Corporation under the designation 125 WPF. It has a fiber length in the approximate range of 2,000-4,000 microns and a fiber width of approximately 20-30 microns. In a typical material, 50-60% of the fibers pass through a 40 mesh screen, 20-30% pass through a 100 mesh screen, and 10-20% pass through a 200 mesh screen. The polyester material has a bulk density of approximately 330-360 ml/50 grams, and the weight per cubic foot of the material is approximately 6 pounds.

This particular composition also includes 0.24% of a refractory fiber mixture. This mixture is sold by American Fillers and Abrasives, Inc. under the designation SF105MA, and comprises a proprietary mixture of alumino silicate fibers together with some cellulose fibers and polyethylene fibers. This particular composition also includes two separate groups of cellulose fibers. The first cellulose fiber is present in an amount of 0.24%. This material is derived from cotton fabric waste and has an approximate length of 300 microns. The second cellulose fiber is also derived from cotton fabric waste. It is present in an amount of 1.4% and has a fiber length of approximately 75 microns. Cellulose fibers of this type are available from American Fillers and Abrasives, Inc. under the respective designations 6W100 and 1W100. The composition also includes an aramid fiber in an amount of 0.1%. The specific fiber employed in this formulation is an expanded aramid fiber available from American Fillers and Abrasives, Inc. The fiber length of this material is approximately 2.0 mm and the fiber diameter is approximately 1-20 microns. This material has a specific gravity of 1.44. The composition also includes a leather fiber in an amount of 0.4%. This fiber is available from Composition Materials Co., Inc.

The foregoing composition also includes an iron oxide pigment in an amount of 0.8% and a gold sparkle pigment in an amount of 0.2%. These ingredients are present for purposes of appearance. In addition, the composition includes 0.4% of a wetting agent (DOS 75-PG).

In another set of embodiments, the foregoing composition may be prepared in a dry form, such as in pellets or capsules. These may be added directly to fluids in the coolant system of an engine or premixed with water and then added to the coolant system.

Other similar compositions, both aqueous and dry, may be prepared by varying the proportions of the materials recited above. For example, the polyester fiber may be varied over a range of 0.5-1.0%, the refractory fiber may be varied over a range of 0.5-0.5%. The first cellulose fiber (if employed) may vary over a range of 0.5-0.5%, and the second cellulose fiber (if employed) over a range of 0.5-5%. The composition may include a leather fiber which may be varied over a range of 0.5-1.0%; the sodium silicate may be varied over a range of 40-80% and the aramid fiber over a range of 0.5-0.5%.

The compositions of the present invention provide a rapid and reliable seal for engine leaks of relatively large and small sizes. In one use of the material, the existing coolant fluid is drained from the engine, the composition of the present invention is introduced thereinto, and the engine is run for a period of time so that the combination of heat and pressure causes the composition to infiltrate and seal the leaks. Once the seal is effectuated, the engine is stopped, the composition drained therefrom, and the coolant fluid replaced. In another mode of use, the composition is added directly to water or coolant fluid, either in a dry form, as a pellet, powder or capsule, or in a liquid base, which may comprise water and/or an organic material such as a glycol, alcohol or ether. In some instances, the composition may be allowed to remain in the engine after the leaks have been sealed.

In view of the teaching presented herein, other modifications and variations of the present invention will be readily apparent to those of skill in the art. The foregoing discussion, description and examples are illustrative of specific embodiments of the invention, but are not meant to be limitations upon the practice thereof. It is the following claims, including all equivalents, which define the scope of the invention.

1. A composition for sealing leaks in an engine, said composition comprising:
a water soluble metal silicate;
a body of organic fibers; and
a body of inorganic fibers.

2. The composition of claim 1, wherein said inorganic fibers are selected from the group consisting of:
glass fibers, ceramic fibers, mineral fibers, and combinations thereof.

3. The composition of claim 1 wherein said organic fibers comprise a plurality of different types of organic fibers.

4. The composition of claim 3, wherein the members of said plurality of different types of organic fibers are selected from the group consisting of: synthetic polymers, vegetable fibers, and animal fibers.

5. The composition of claim 3, wherein said vegetable fibers comprise cellulose fibers.

6. The composition of claim 4, wherein said cellulose fibers are of at least two different lengths.

7. The composition of claim 3, wherein said animal fibers comprise leather fibers.

8. The composition of claim 3, wherein said fibers of a synthetic polymer comprise fibers of at least two different synthetic polymers.

9. The composition of claim 3, wherein said synthetic polymer is a fibrillated polymer.

10. The composition of claim 3, wherein said synthetic polymer is an aramid polymer.

11. The composition of claim 3, wherein said synthetic polymer is a thermoplastic polymer.

12. The composition of claim 1, wherein said metal silicate comprises sodium silicate.

13. A composition for sealing leaks in an engine, said composition comprising:
a water-soluble metal silicate;
a first polymeric fiber;
a refractory fiber;
a first cellulose fiber;
a second cellulose fiber;
a leather fiber;
a second polymeric fiber which is an aramid polymer; and
water.

14. The composition of claim 13, further including an ancillary ingredient selected from the group consisting of: thickeners, pigments, dyes, wetting agents, and fragrances.

15. A composition for sealing leaks in an engine, said composition comprising, on a weight basis:
40-80 percent of a water-soluble metal silicate;
0.5-1.0 percent of a first, fibrillated polymeric fiber;
0.5-0.5 percent of a second, aramid polymeric fiber;
0.5-0.5 percent of a refractory fiber;
0.5-0.5 percent of a first cellulose fiber having a first length;
0.5-5.0 percent of a second cellulose fiber having a second length different from said first length;
0.5-1.0 percent of a leather fiber; and
the balance water.

16. The composition of claim 15, further including 0.5-1.0 percent by weight of a thickener.
